(19) United States
(12) Patent Application Publication
(10) Pub. No.: US 2013/0164625 A1
(43) Pub. Date: Jun. 27, 2013

(54) SULFUR-CARBON COMPOSITE CATHODES FOR RECHARGEABLE LITHIUM-SULFUR BATTERIES AND METHODS OF MAKING THE SAME

(71) Applicants: Arumugam Manthiram, Austin, TX (US); Yu-Sheng Su, Austin, TX (US)

(72) Inventors: Arumugam Manthiram, Austin, TX (US); Yu-Sheng Su, Austin, TX (US)

(21) Appl. No.: 13/335,486

(22) Filed: Dec. 22, 2011

(51) Int. Cl. H01M 4/583; C01B 31/26; B82Y 30/00; B82Y 40/00

(52) U.S. Cl. 429/231.8; 423/439; 977/948; 977/742; 977/734; 977/842

(57) ABSTRACT

This disclosure relates to a method of synthesizing a sulfur-carbon composite comprising forming an aqueous solution of a sulfur-based ion and carbon source, adding an acid to the aqueous solution such that the sulfur-based ion nucleates as sulfur upon the surface of the carbon source; and forming an electrically conductive network from the carbon source. The sulfur-carbon composite includes the electrically conductive network with nucleated sulfur. It also relates to a sulfur-carbon composite comprising a carbon-based material, configured such that the carbon-based material creates an electrically conductive network and a plurality of sulfur granules in electrical communication with the electrically conductive network, and configured such that the sulfur granules are reversibly reactive with alkali metal. It further relates to batteries comprising a cathode comprising such a carbon-based material along with an anode and an electrolyte.

### TECHNICAL FIELD

The current disclosure relates to methods of making sulfur-carbon composites usable as cathodes in batteries, particularly lithium-sulfur secondary (rechargeable) batteries. The disclosure also relates to sulfur-carbon composites and to cathodes and batteries containing such composites.

### BACKGROUND

### Basic Principles of Batteries and Electrochemical Cells

Batteries may be divided into two principal types, primary batteries and secondary batteries. Primary batteries may be used once and are then exhausted. Secondary batteries are also often called rechargeable batteries because after use they may be connected to an electricity supply, such as a wall socket, and recharged and used again. In secondary batteries, each charge/discharge process is called a cycle. Secondary batteries eventually reach an end of their usable life, but typically only after many charge/discharge cycles.

Secondary batteries are made up of an electrochemical cell and optionally other materials, such as a casing to protect the cell and wires or other connectors to allow the battery to interface with the outside world. An electrochemical cell includes two electrodes, the positive electrode or cathode and the negative electrode or anode, an insulator separating the electrodes so the battery does not short out, and an electrolyte that chemically connects the electrodes.

In operation the secondary battery exchanges chemical energy and electrical energy. During discharge of the battery, electrons, which have a negative charge, leave the anode and travel through outside electrical conductors, such as wires in a cell phone or computer, to the cathode. In the process of traveling through these outside electrical conductors, the electrons generate an electrical current, which provides electrical energy.

At the same time, in order to keep the electrical charge of the anode and cathode neutral, an ion having a positive charge leaves the anode and enters the electrolyte and a positive ion also leaves the electrolyte and enters the cathode. In order for this ion movement to work, typically the same type of ion leaves the anode and joins the cathode. Additionally, the electrolyte typically also contains this same type of ion. In order to recharge the battery, the same process happens in reverse. By supplying energy to the cell, electrons are induced to leave the cathode and join the anode. At the same time a positive ion, such as Li⁺, leaves the cathode and enters the electrolyte and a Li⁺ leaves the electrolyte and joins the anode to keep the overall electrode charge neutral.

In addition to containing an active material that exchanges electrons and ions, anodes and cathodes often contain other materials, such as a metal backing to which a slurry is applied and dried. The slurry often contains the active material as well as a binder to help it adhere to the backing and conductive materials, such as a carbon particles. Once the slurry dries it forms a coating on the metal backing.

Unless additional materials are specified, batteries as described herein include systems that are merely electrochemical cells as well as more complex systems.

Several important criteria for rechargeable batteries include energy density, power density, rate capability, cycle life, cost, and safety. The current lithium-ion battery technology based on insertion compound cathodes and anodes is limited in energy density. This technology also suffers from safety concerns arising from the chemical instability of oxide cathodes under conditions of overcharge and frequently requires the use of expensive transition metals. Accordingly, there is immense interest to develop alternate cathode materials for lithium-ion batteries. Sulfur has been considered as one such alternative cathode material.

### Lithium-Sulfur Batteries

Lithium-sulfur (Li—S) batteries are a particular type of rechargeable battery. Unlike most rechargeable batteries in which the ion actually moves into and out of a crystal lattice, the ion on lithium sulfur batteries reacts with lithium in the anode and with sulfur in the cathode even in the absence of a precise crystal structure. In most Li—S batteries the anode is lithium metal (Li or) Li⁰. In operation lithium leaves the metal as lithium ions (Li⁺) and enters the electrolyte when the battery is discharging. When the battery is recharged, lithium ions (Li⁺) leave the electrolyte and plate out on the lithium metal anode as lithium metal (Li). At the cathode, during discharge, particles of elemental sulfur (S) react with the lithium ion (Li⁺) in the electrolyte to form Li₂S. When the battery is recharged, lithium ions (Li⁺) leave the cathode, allowing to revert to elemental sulfur (S).

Sulfur is an attractive cathode candidate as compared to traditional lithium-ion battery cathodes because it offers an order of magnitude higher theoretical capacity (1675 mAh g⁻¹) than the currently employed cathodes (<200 mAh g⁻¹) and operates at a safer voltage range (1.5-2.5 V). In addition, sulfur is inexpensive and environmentally benign.

However, the major problem with a sulfur cathode is its poor cycle life. The discharge of sulfur cathodes involves the formation of intermediate polysulfide ions, which dissolve easily in the electrolyte during the charge-discharge process and result in an irreversible loss of active material during cycling. The higher-order polysulfides (Li₂Sₙ²⁻, 4≦n≦8) produced during the initial stage of the discharge process are soluble in the electrolyte and move toward the lithium metal anode, where they are reduced to lower-order polysulfides. Moreover, solubility of these high-order polysulfides in the liquid electrolytes and nucleation of the insoluble low-order sulfides (i.e., Li₂S₂ and Li₂S) result in poor capacity retention and low Coulombic efficiency. In addition, shuttling of these high-order polysulfides between the cathode and anode during charging, which involves parasitic reactions with the lithium anode and re-oxidation at the cathode, is another challenge. This process results in irreversible capacity loss and causes the build-up of a thick irreversible Li₂S barrier on the electrodes during prolonged cycling, which is electrochemically inaccessible. Overall, the operation of Li—S cells is so dynamic that novel electrodes with optimized compositions and structure are needed to maintain the high capacity of sulfur and overcome the challenges associated with the solubility and shuttling of polysulfides.

Moreover, sulfur is an insulator with a resistivity of 5×10⁻³⁰ S cm⁻¹ at 25° C., resulting in a poor electrochemical utilization of the active material and poor rate capacity. Although the addition of conductive carbon to the sulfur material could improve the overall electrode conductivity, the core of the sulfur particles, which have little or no contact with conductive carbon, will still be highly resistive.

Previous attempts to address the conductivity problem have sought to increase the fraction of sulfur in contact with carbon. Several approaches have been pursued, such as forming sulfur-carbon composites with carbon black or nanostructured carbon. For example, a mesoporous carbon framework filled with amorphous sulfur with the addition of polymer has been found to exhibit a high reversible capacity of approximately 1000 mAh g⁻¹ after 20 cycles. However, most traditional methods to synthesize sulfur-carbon composites include processing by a sulfur melting route, resulting in high manufacturing costs due to additional energy consumption. Also, several reports have noted that the sulfur content in the sulfur-carbon composites synthesized by the sulfur melting route is limited to a relatively low value in order to obtain acceptable electrochemical performance, leading to a lower overall capacity of the cathode.

Moreover, synthesizing homogeneous sulfur-carbon composites through conventional heat treatment is complicated. In the conventional synthesis of sulfur-carbon composites, sulfur is first heated above its melting temperature, and the liquid sulfur is then diffused to the surface or into the pores of carbon substrates to form the sulfur-carbon composite. A subsequent high-temperature heating step is then required to remove the superfluous sulfur on the surface of the composites, leading to a waste of some sulfur. Thus, the conventional synthesis by the sulfur melting route may not be scaled-up in a practical manner to obtain a uniform industry-level sulfur-carbon composite.

As another alternative, a sulfur deposition method to synthesize a core-shell carbon/sulfur material for lithium-sulfur batteries has been recently reported. Although this process exhibited acceptable cyclability and rate capability, the sulfur deposition process is very sensitive and must be carefully controlled during synthesis. Otherwise, a composite with poor electrochemical performance is produced.

Therefore, there remains a need for an easily scalable chemical synthesis for forming sulfur-carbon composites with low manufacturing cost.

### SUMMARY

Accordingly, certain embodiments of the disclosure described in this disclosure present a facile sulfur deposition route to synthesize sulfur-carbon composites, which not only offers a low-cost approach for large-scale production, but also produces high-purity active material.

One embodiment of the present disclosure is a method of synthesizing a sulfur-carbon composite comprising forming an aqueous solution of a sulfur-based ion and carbon source, adding an acid to the aqueous solution such that the sulfur-based ion nucleates as sulfur upon the surface of the carbon source; and forming an electrically conductive network from the carbon source. The sulfur-carbon composite includes the electrically conductive network with nucleated sulfur.

An alternative embodiment of the present disclosure is a sulfur-carbon composite comprising a carbon-based material, configured such that the carbon-based material creates an electrically conductive network. The composite also includes a plurality of sulfur granules in electrical communication with the electrically conductive network. The composite is configured such that the sulfur granules are reversibly reactive with alkali metal.

Another embodiment of the present disclosure is a battery comprising a cathode, comprising a carbon-based material, configured such that the carbon-based material creates an electrically conductive network. The cathode also includes a plurality of sulfur granules in electrical communication with the electrically conductive network. The composite is configured such that the sulfur granules are reversibly reactive with alkali metal. The battery may also include an anode and an electrolyte.

The following abbreviations are commonly used throughout the specification: Li⁺—lithium ion
Li or Li⁰—elemental or metallic lithium or lithium metal
S—sulfur
Li—S—lithium-sulfur
Li₂S—lithium sulfide
S—C—sulfur-carbon
Na₂S₂O₃—sodium thiosulfate
K₂5₂0₃—potassium thiosulfate
MₓS₂O₃—metal thiosulfate
H⁺—hydrogen ion
HCl—hydrochloric acid
C₃H₈O—isopropyl alcohol
DI—deionized
PVDF—polyvinylidene fluoride
NMP—N-methylpyrrolidinone
DME—1,2-dimethoxyethane
DOL—1,3-dioxolane
TGA—thermogravimetric analysis
SEM—scanning electron microscope
XRD—X-ray diffraction
TEM—transmission electron microscope
EDS—energy dispersive spectrometer
CV—cyclic voltammetry
EIS—electrochemical impedance spectroscopy

### BRIEF DESCRIPTION OF THE DRAWINGS

A more complete understanding of the present embodiments and advantages thereof may be acquired by referring to the following description taken in conjunction with the accompanying drawings, which relate to embodiments of the present disclosure. The current specification contains color drawings. Copies of these drawings may be obtained from the USPTO.

FIG. 1 illustrates an in situ sulfur deposition route to obtain a sulfur-carbon composite.

FIG. 2 provides XRD patterns of pure sulfur, a sulfur-carbon composite, and carbon black with Cu Kα radiation between 10° and 70° at a scan rate of 0.04°/s.

FIGS. 3A-3C provide SEM images of certain compounds. FIG. 3A provides an SEM image of carbon black; the bar is 200 nm. FIG. 3B provides an SEM image of pure sulfur; the bar is 10 μm. FIG. 3C provides an SEM image of a sulfur-carbon composite; the bar is 10 μm.

FIG. 4 illustrates the correlation between the SEM image of FIG. 3C and the reaction illustrated in FIG. 1.

FIGS. 5A-5C provide characterization data of a sulfur-carbon composite. FIG. 5A illustrates a low magnification TEM image of a sulfur-carbon composite; the bar is 100 nm. FIG. 5B illustrates a high magnification TEM image of a sulfur-carbon composite; the bar is 20 nm. FIG. 5C illustrates EDS analysis for sulfur and carbon.

FIG. 6A illustrates cycle data for the 1st, 2nd, and 3rd cycles of a pure sulfur electrode at a scan rate of 0.05 mV s⁻¹ under a voltage window of 1.0-3.5 V (vs. Li⁺/Li). FIG. 6B illustrates cycle data for the 1st, 2nd, and 3rd cycles of a sulfur-carbon composite electrode at a scan rate of 0.05 mV s⁻¹ under a voltage window of 1.0-3.5 V (vs. Li⁺/Li).

FIGS. 7A and 7B illustrate the improved cycle characteristics of a sulfur-carbon composite. FIG. 7A illustrates the first discharge/charge profile of the pure sulfur and sulfur-carbon composite cathodes cycled at 1.5-2.8 V (vs. Li⁺/Li) at a rate of C/20. FIG. 7B illustrates discharge curves at 1, 2, 3, and 30 cycles of the pure sulfur and sulfur-carbon composite cathodes cycled at 1.5-2.8 V (vs. Li⁺/Li) at a rate of C/20.

FIGS. 8A and 8B illustrate a comparison of the cyclability of the pure sulfur and a sulfur-carbon composite. FIG. 8A provides a comparison of the discharge capacity of the pure sulfur and sulfur-carbon composite cathodes at a rate of C/20. FIG. 8B provides a comparison of the discharge capacity of the pure sulfur and sulfur-carbon composite cathodes at rates of C/20, C/10, C/5, and C/4.

FIGS. 9A-9D provide SEM images of cathodes. FIG. 9A provides an image of a pure sulfur cathode before cycling; the bar is 10 μm. FIG. 9B provides an image of a sulfur-carbon composite cathode before cycling; the bar is 10 μm. FIG. 9C provides an image of a pure sulfur cathode after cycling at C/5 rate for 25 cycles; the bar is 10 μm. FIG. 9D provides an image of a sulfur-carbon composite cathode after cycling at C/5 rate for 25 cycles; the bar is 10 μm.

FIG. 10 provides an electrochemical impedance spectra, in the frequency range of 1 MHz to 100 mHz and with an AC voltage amplitude of 5 mV, of pure sulfur and sulfur-carbon composite cathodes before and after cycling at C/5 rate.

### DETAILED DESCRIPTION

The current disclosure relates to methods of making a sulfur-carbon (S—C) composite for use as a cathode in a lithium-sulfur (Li—S) battery. It also relates to the composite thus formed and cathodes and batteries containing such a material.

### Method of Forming Sulfur-Carbon Composite

According to one embodiment, the disclosure provides a method of forming an S—C composite by nucleating sulfur deposition on a conductive carbon matrix. In some embodiments, this may be characterized as in situ sulfur deposition synthesis. The carbon source for the conductive matrix may be carbon/graphite powders, porous carbon/graphite particles, carbon nanotubes, carbon nanofibers, graphene, any conductive carbon materials, or combinations thereof. The sulfur source may be a metal thiosulfate (MₓS₂O₃) such as sodium thiosulfate (Na₂S₂O₃) or potassium thiosulfate (K₂S₂O₃), or any other compounds with a thiosulfate ion or other sulfur-based ions.

In some embodiments, an aqueous solution of sulfur-based ions from the sulfur source and the carbon source may be formed. In certain embodiments, the solution may serve to facilitate the formation of sulfur-based ions from the sulfur source and to allow dispersion of the sulfur-based ions and carbon to facilitate the reaction of the sulfur-based ions with an acid and to facilitate nucleation of sulfur on carbon. The aqueous solution of sulfur-based ions and carbon thus formed may be a dilute aqueous solution. In some embodiments, a wetting agent may be added to enhance the distribution of the carbon source in the solution. In some embodiments, this wetting agent may be isopropyl alcohol, acetone, ethanol, or any other organic solvent able to facilitate the dispersal of the carbon source throughout the aqueous solution. An acid may then be added to cause sulfur-based ions to nucleate onto the surface of the carbon source as sulfur. In some embodiments, the sulfur may nucleate within the interspaces of the carbon source or on the surface of the electrically conductive network. This acid may be hydrochloric acid, or any other H⁺ source able to facilitate the precipitation of sulfur by providing H⁺ either directly or indirectly to the sulfur-based ions. Additionally, the carbon source may form an electrically conductive network. This network may form at approximately the same time as or after when nucleation of the sulfur occurs. However, if the carbon particles have a special structure within themselves that forms part of the electrically conductive network, such network portion will exist be prior to the sulfur nucleation.

The reaction mixture may be stirred for a duration of time, and then the precipitate, which includes the electrically conductive network with nucleated sulfur, may be gathered. In some embodiments, this may be for 24 hours. In other embodiments, the duration may be modified by changing the concentration of reagents. In some embodiments, this reaction proceeds at any temperature below 120° C., the melting point of sulfur. In some embodiments, the reaction may be at room temperature. The precipitate, including the electrically conductive network with nucleated sulfur, may then be gathered and washed. This may involve filtration, and washing with water, ethanol, acetone, or other solutions that do not substantially dissolve the precipitate. The washed precipitate may then be dried. In some embodiments, the precipitate may be dried in an air-oven at 50° C. for 24 hours. In some embodiments, substantially all of the water is removed from the sulfur-carbon composite through washing and drying. In particular, sufficient water may be removed to allow safe use of the sulfur-carbon composite with a Li anode, which may react with water, causing damage to the battery or even an explosion if too much residual water is present.

This method provides several improvements over other conventional methods used to create a carbon and sulfur based cathode. For example, the synthesis may take place in an aqueous solution. This allows for the use of less toxic or less caustic reagents. This also creates a synthesis pathway that is easier to achieve and easier to scale up. The sulfur-carbon composite obtained has uniform distribution of sulfur and carbon. In addition, the sulfur-carbon composite is pure, with a majority of undesired components being removed from the sulfur-carbon composite during the synthesis process. Purity of the compound may be assessed, for example, by X-ray diffraction, in which any impurities show up as additional peaks. Further, the synthesis process of the present disclosure does not require a subsequent heat treatment or purification process. This decreases time and energy requirements over other conventional methods, allowing for a lower cost method for creation of sulfur-based battery materials.

Sulfur-Carbon Composites

According to another embodiment, the disclosure also includes a sulfur-carbon composite including a carbon matrix with sulfur deposited thereon. This sulfur-carbon composite may be used in a cathode as the active material. Sulfur at an interface with the carbon may be chemically bonded to it, while sulfur located elsewhere is not bonded to the carbon. Alternatively, the sulfur and carbon, particularly near the interface may be physically attached, but not chemically bonded to one another, for example by Van der Waal's forces.

In some embodiments, there may be aggregations of sulfur surrounded by a network of carbon material made of carbon-based particles. These aggregations of sulfur may be on the order of a few micrometers in diameter. For example, they may be less than 15 micrometers in diameter, or they may be between 0.5 and 10 micrometers in diameter. The individual carbon-based particles of the network may be less than 150 nanometers in diameter, or between 10 and 100 nanometers in diameter. The carbon-based particles may be bonded to each other, or they may be merely contacting each other. The carbon-based particles may further be in electrical communication with one another, such that the network surrounding the sulfur aggregations may provide improved electrical conductivity over pure sulfur. The sulfur-carbon composite may be formed by following the method described above. In some embodiments, the sulfur-carbon composite may suppress the migration of soluble polysulfides out of the composite. This may be facilitated by the encasing of the sulfur particles within carbon.

The sulfur-carbon composite has excellent conductivity and electrochemical stability in comparison with a cathode composed largely of sulfur alone.

### Cathodes and Batteries

The disclosure also includes cathodes made using a sulfur-carbon composite as described above as the active material. Such cathodes may include a metal or other conductive backing and a coating containing the active material. The coating may be formed by applying a slurry to the metal backing The slurry and resulting coating may contain particles of the active material. The cathode may contain only one type of active material, or it may contain multiple types of active materials, including additional active materials different from those described above. The coating may further include conductive agents, such as carbon. Furthermore, the coating may contain binders, such as polymeric binders, to facilitate adherence of the coating to the metal backing or to facilitate formation of the coating upon drying of the slurry. In some embodiments the cathode may be in the form of metal foil with a coating. In some embodiments, a slurry may contain a sulfur-carbon composite, carbon black, and a PVDF binder in an NMP solution. This slurry may be tape-casted onto a sheet of aluminum foil and dried in a convection oven at 50° C. for 24 hours.

In another embodiment, the disclosure relates to a battery containing a cathode including an active material as described above. The cathode may be of a type described above. The battery may further contain an anode and an electrolyte to complete the basic components of an electrochemical cell. The anode and electrolyte may be of any sort able to form a functional rechargeable battery with the selected cathode material. In one embodiment, the anode may be a lithium metal (Li or Li⁰ anode). The battery may further contain contacts, a casing, or wiring. In the case of more sophisticated batteries it may contain more complex components, such as safety devices to prevent hazards if the battery overheats, ruptures, or short circuits. Particularly complex batteries may also contain electronics, storage media, processors, software encoded on computer readable media, and other complex regulatory components.

Batteries may be in traditional forms, such as coin cells or jelly rolls, or in more complex forms such as prismatic cells. Batteries may contain more than one electrochemical cell and may contain components to connect or regulate these multiple electrochemical cells. Sulfur-carbon composites of the present disclosure may be adapted to any standard manufacturing processes or battery configurations.

Batteries of the present disclosure may be used in a variety of applications. They may be in the form of standard battery size formats usable by a consumer interchangeably in a variety of devices. They may be in power packs, for instance for tools and appliances. They may be usable in consumer electronics including cameras, cell phones, gaming devices, or laptop computers. They may also be usable in much larger devices, such as electric automobiles, motorcycles, buses, delivery trucks, trains, or boats. Furthermore, batteries according to the present disclosure may have industrial uses, such as energy storage in connection with energy production, for instance in a smart grid, or in energy storage for factories or health care facilities, for example in the place of generators.

Batteries using a sulfur-carbon composite may enjoy benefits over prior art batteries. For example, the sulfur-carbon composite may decrease the charge transfer resistance and help maintain the integrity of an electrode structure during cycling. Additionally, the carbon network surrounding the sulfur may play a protective role as an adsorbent agent to keep the soluble polysulfides within the electrode structure, avoiding the unwanted shuttle effect during charging.

### EXAMPLES

The following examples are provided to further illustrate specific embodiments of the disclosure. They are not intended to disclose or describe each and every aspect of the disclosure in complete detail and should be not be so interpreted.

### Example 1

### Formation of Sulfur-Carbon Composite

Sulfur-carbon composites and pure sulfur materials used in Examples 2-7 herein were prepared as described in this Example 1.

A sulfur-carbon composite according to one embodiment of the present disclosure was synthesized by an in situ sulfur deposition route in aqueous solution involving the following reaction:

Na₂S₂O₃+2HCl→2NaCl+SO₂+H₂O+S↓ (1)

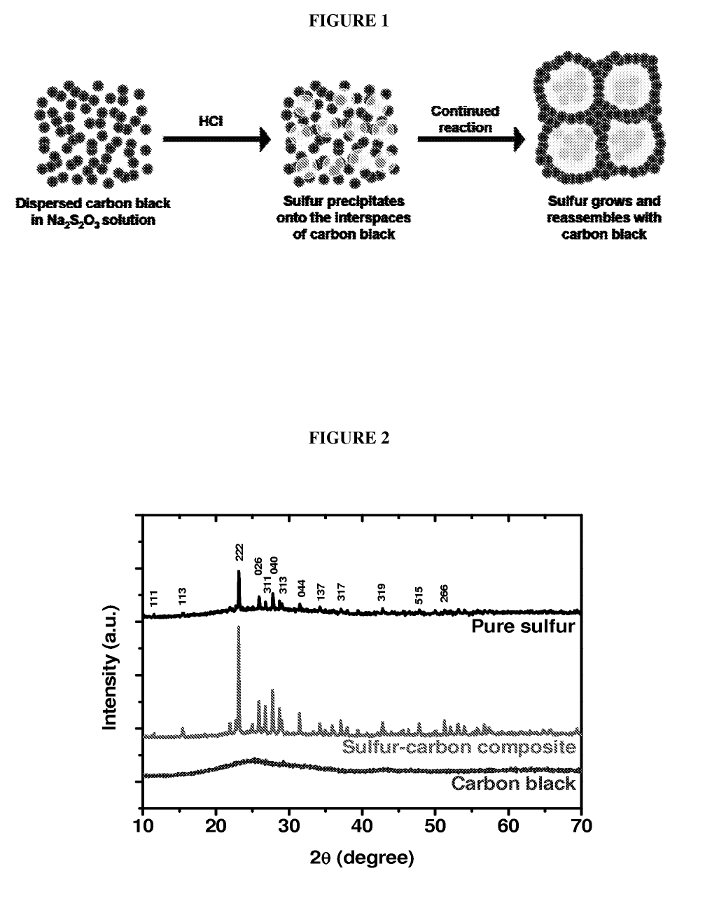

FIG. 1 is an illustration of the deposition route of the reaction to obtain the sulfur-carbon composite. First, sodium thiosulfate (Na₂S₂O₃; Fisher Scientific) was completely dissolved in 750 mL of deionized (DI) water by stirring. Then, commercial conductive carbon black (Super P) was suspended in the above solution by adding a small amount of isopropyl alcohol (C₃H₈O; Fisher Scientific) under ultrasonic vibrations. The isopropyl alcohol enhances the wetting of the hydrophobic carbon nanoparticles in the aqueous solution. 20 mL of hydrochloric acid (HCl; Fisher Scientific) was then slowly added to the solution to nucleate the sulfur onto the surface and into the interspaces of the nano-sized carbon black or on the surface of the electrically conductive network. After allowing the reaction mixture to stir for 24 hours, the product was filtered and washed several times with DI water, ethanol, and acetone. The sulfur-carbon composite thus formed was filtered and dried in an air-oven at 50° C. for 24 hours. The sulfur content in the composite was determined by thermogravimetric analysis (TGA) with a Perkin-Elmer TGA 7 Thermogravimetric Analyzer at a heating rate of 5° C./min from 30 to 300° C. with flowing air. During this process, all the sulfur volatilizes and the sulfur content could be obtained from the observed weight loss. The sulfur-carbon composites were confirmed to have 75 wt. % sulfur by the TGA data. For purposes of comparison, pure sulfur was also synthesized in the same manner as the composite, but without the addition of carbon black.

### Example 2

### X-Ray Diffraction Analysis of Sulfur-Carbon Composite

The sulfur-carbon composites and pure sulfur materials described in Example 1 were characterized with a Philips X-ray Diffractometer (PW 1830+APD 3520) with Cu Kα radiation between 10° and 70° at a scan rate of 0.04°/s. FIG. 2 compares the X-ray diffraction (XRD) patterns of the pure sulfur, sulfur-carbon composite, and carbon black. The Super P carbon black, showing no sharp crystalline peaks, has an amorphous structure. The pure sulfur and sulfur-carbon composite exhibit peaks perfectly matching with those of pure orthorhombic sulfur (JCPDS 00-008-0247). The sulfur-carbon composite shows much higher peak intensities than the pure sulfur as the dispersed nanoparticles of carbon black act as numerous deposition sites for elemental sulfur, leading to a favorable precipitation environment. This in situ sulfur deposition route thus provides an efficient means to produce high-purity sulfur composites.

### Example 3

### Microstructure and Morphology Analysis of Sulfur-Carbon Composite

The microstructure and morphology of the sulfur-carbon composites described in Example 1 were examined with a JEOL JSM-5610 and a FEI Quanta 650 scanning electron microscope (SEM) and a JEOL JEM-2010F transmission electron microscope (TEM). The composition of the sulfur-carbon composite was also determined with an energy dispersive spectrometer (EDS) attached to the TEM instrument.

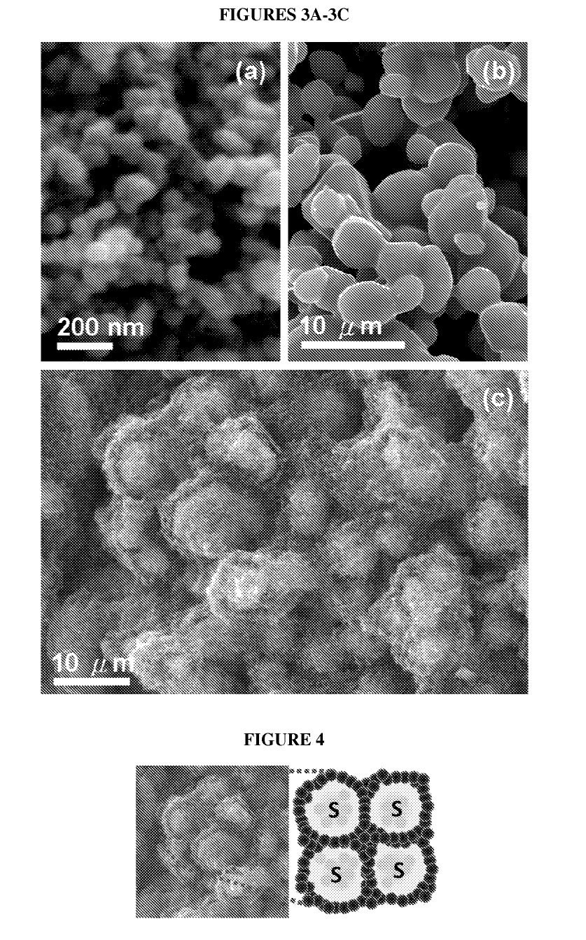

The microstructures of the carbon black, pure sulfur, and sulfur-carbon composite as observed using SEM are shown in FIGS. 3A-3C, respectively. FIG. 3A illustrates the SEM image of the carbon black. As shown in FIG. 3A, the particle size of spherical carbon black is less than 100 nm. FIG. 3B illustrates the SEM image of the pure sulfur. As shown in FIG. 3B, the pure sulfur contains glue-like particles with a diameter of few microns. FIG. 3C illustrates the structure of the sulfur-carbon composite in which sulfur particles are uniformly distributed throughout the network structure formed by carbon black. Carbon black partially embeds in the sulfur, and the remainder wraps around the matrix sulfur as a protective layer. This network structure confirms close contact between the conductive carbon and sulfur, providing not only excellent electron pathways for the insulating sulfur but also many adsorbent points to avoid the loss of the soluble polysulfides into the electrolyte. FIG. 4 illustrates the correlation between SEM images and the reaction progression illustrated in FIG. 1.

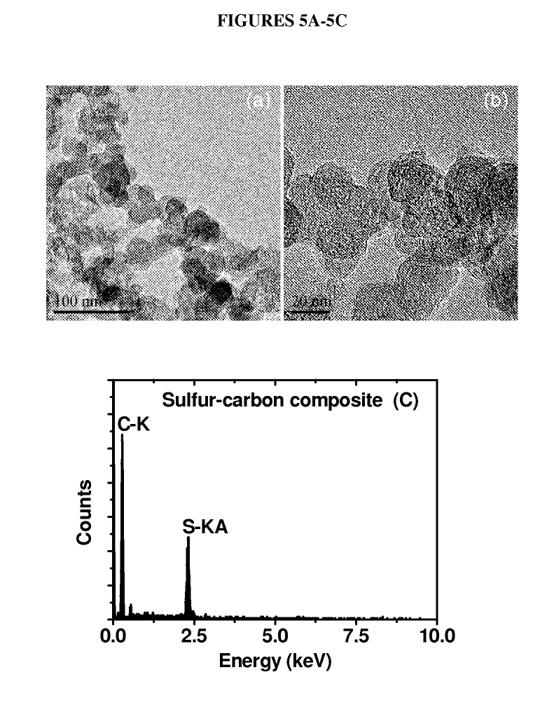

FIGS. 5A and 5B illustrate low and high magnifications, respectively, of TEM images of the sulfur-carbon composite. These figures illustrate that the carbon black nanoparticles in the sulfur-carbon composite are chain-like, which effectively enhances the conductivity of the composite. The elemental analysis of the sulfur-carbon composite carried out by EDS is shown in FIG. 5C, demonstrating the existence of both sulfur and carbon in the composite.

### Example 4

### Battery Using Sulfur-Carbon Composite

Sulfur-carbon composite and pure sulfur material batteries as used in Examples 5-7 herein were prepared as described in this Example 4.

The sulfur-carbon composite from Example 1 was individually mixed with 10 wt. % of Super P and 10 wt. % of polyvinylidene fluoride (PVDF; Kureha) binder in an N-methylpyrrolidinone (NMP; Sigma-Aldrich) solution. The well-mixed slurry was tape-casted onto a sheet of aluminum foil and the film was dried in a convection oven at 50° C. for 24 h, followed by pressing with a roller and punching out circular electrodes 0.5 inch in diameter. The cathode electrode disks were dried in a vacuum oven at 50° C. for an hour before assembling the cell. Similar electrodes with the same overall amount of sulfur were also fabricated with the synthesized pure sulfur under the same conditions. Next, 1.0 M LiCF₃SO₃ (Acros Organics) salt was added to a mixture of 1,2-Dimethoxyethane (DME; Acros Organics) and 1,3-Dioxolane (DOL; Acros Organics) (1:1, v/v) and stirred for 5 min to prepare the electrolyte. The CR2032 coin cells were then assembled with the prepared cathode disks, prepared electrolyte, Celgard polypropylene separators, lithium foil anodes, and nickel foam current collectors. The cell assembly was conducted in a glove box filled with argon.

### Example 5

### Cyclic Voltammetry of a Battery Using Sulfur-Carbon Composite

To understand the reduction/oxidation reactions of the sulfur-carbon composite batteries of Example 4, cyclic voltammetry (CV) was performed for both the sulfur-carbon composite batteries and the pure sulfur batteries. The CV data were collected with a VoltaLab PGZ 402 Potentiostat at a scan rate of 0.05 mV/s between 3.5 and 1.0 V. The charge-discharge profiles, cyclability, and rate capability were assessed with an Arbin battery cycler. All cells were rested for 30 minutes before electrochemical cycling. The cells were then discharged to 1.5 V and charged to 2.8 V or achieved a capacity of 1 C (C=1675 mAh g⁻¹) to avoid the infinite charging from the shuttle effect for one full cycle. Unless otherwise noted, the cycling was done at a rate of C/20.

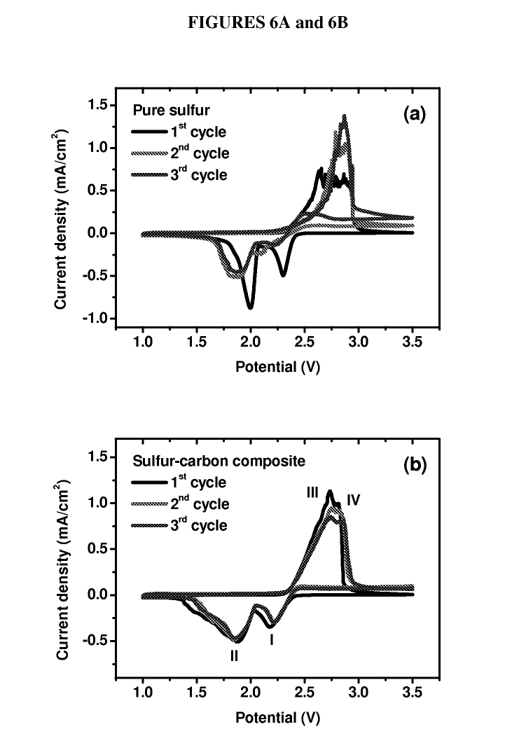

FIG. 6A illustrates CV data for the first three cycles for a pure sulfur cathode of Example 4. For the pure sulfur cathode, two sharp cathodic peaks located at 2.3 and 2.0 V are observed in the first discharge process in FIG. 6A, corresponding to the reduction of elemental sulfur to soluble polysulfides and then to the insoluble Li₂S₂ and Li₂S, respectively. Several anodic peaks occur continuously with similar current density from 2.3 to 3.0 V as the potential scans to the charging voltage. These oxidation peaks occurring in a broad voltage range suggest poor charging efficiency and severe polarization. In the subsequent cycles, both the reduction peaks shift to lower potential ranges compared to that in the first cycle, indicating a discharge overpotential after recharging. The current densities of both the reduction peaks also drop in the second and third cycles, indicating the irreversible capacity fade of the as-synthesized pure sulfur cathode. The CV profile of the sulfur-carbon composite cathode synthesized by the in situ sulfur deposition route is illustrated in FIG. 6B. The CV patterns in the first three cycles almost overlap each other in contrast to that found with pure sulfur cathode in FIG. 6A, indicating the excellent cyclability of the sulfur-carbon composite cathode. A small increase in the discharge potential of the first reduction peak (Peak I) is observed in the second and third cycles compared to that in the first cycle. This may be due to the higher adsorbing energy between carbon black and sulfur in the first cycle compared to that in the subsequent cycles. The oxidation reaction can be divided into two overlapping peaks (Peak III and IV), representing the formation of Li₂Sₙ (n>2) and elemental sulfur, respectively.

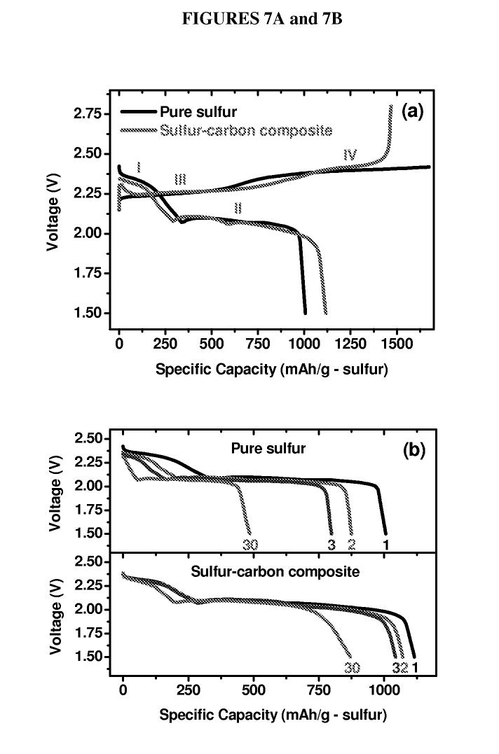

The first discharge/charge profiles of the pure sulfur and sulfur-carbon composite cathodes are shown in FIG. 7A. In the discharge profile, the two discharge plateaus (Plateau I and II) are related to the two peaks (Peaks I and II) mentioned with the CV data. The upper discharge plateau of the pure sulfur cathode is at a slightly higher voltage than that of the sulfur-carbon composite cathode. This evidences the benefit of superior contact between conductive carbon nanoparticles and the insulating sulfur in the sulfur-carbon composite network structure. In the charge profile, the two plateaus (Plateau III and IV) of the sulfur-carbon composite cathode correspond to the two oxidation reactions exhibited in the CV plots as well. The terminal states of the charge process in the pure sulfur and sulfur-carbon composite cathodes are quite distinct. The charge process in the sulfur-carbon composite cathode ends with a sharp voltage raise when the cell voltage reaches 2.8 V. In contrast, the charge process in the pure sulfur cathode shows a typical shuttle behavior even after the charge capacity reaches over 1 C, leading to poor charge efficiency and loss of active material. The adsorption of the polysulfides in the carbon-wrapped sulfur network structure of the sulfur-carbon composite appears to prevent the soluble polysulfides from migrating toward the anode region, thereby efficiently suppressing the shuttle effect at a low current density (C/20) during charging.

FIG. 7B displays the discharge profiles at various cycle numbers of the pure sulfur and the sulfur-carbon composite cathodes. The upper discharge plateau of the pure sulfur cathode continuously shrinks as the cycle number increases, which is consistent with the diminished reduction peaks in FIG. 6A. This indicates the irreversible loss of active sulfur in the cathode. After the 30^{th} cycle, the discharge capacity is less than half of the initial capacity, showing poor electrochemical stability. In contrast, the sulfur-carbon composite cathode has overlapping upper plateaus in the first three cycles, showing excellent electrochemical reversibility. The discharge capacity of the sulfur-carbon composite cathode after the 30^{th} cycle has a retention rate of 78%, which is much higher than that found with the pure sulfur cathode.

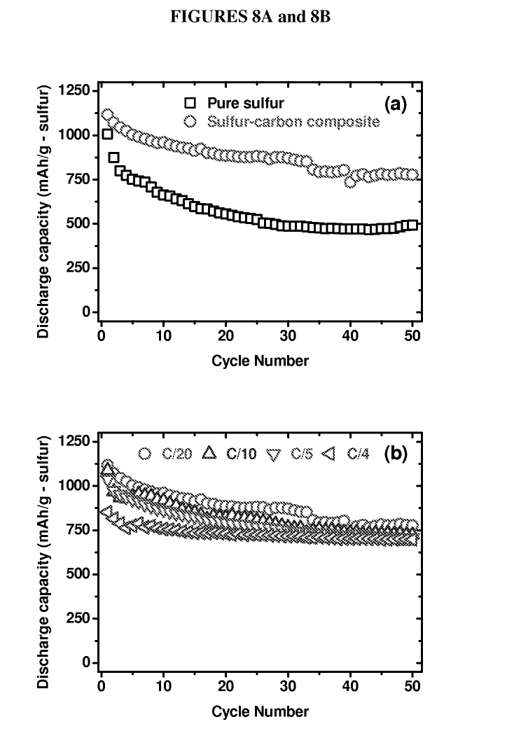

The cyclabilities of the pure sulfur and sulfur-carbon composite cathodes are compared in FIG. 8A. The sulfur-carbon composite cathode has a higher first discharge capacity of 1116 mAh g⁻¹ compared to 1006 mAh g⁻¹ for the pure sulfur cathode, implying that improved active material utilization can be achieved when sulfur is well-distributed in the carbon network structure due to the increased contact area between conductive carbon black and insulating sulfur. The reversible discharge capacity of the sulfur-carbon composite cathode after the 50^{th} cycle is 777 mAh g⁻¹. This reversible capacity value largely exceeds that of the pure sulfur cathode, indicating the superior cyclability of the sulfur-carbon composite cathode. The cycle life plots of the sulfur-carbon composite cathode at various rates are shown in FIG. 8B. As previously encountered, the first discharge capacity decreases with increasing current density or C rate. At a rate of C/4, the reversible discharge capacity after 50 cycles still remains at 697 mAh g⁻¹, representing an 82% capacity retention. This excellent cycle performance makes the sulfur-carbon composite cathodes promising candidates for high rate practical Li—S batteries.

### Example 6

### Morphological Changes During Charge Cycles of a Battery Using Sulfur-Carbon Composite

The morphological changes due to charge cycles for the batteries of Example 4 were examined. After cycling at a rate of C/5 for 25 cycles, the coin cells of Example 4 were opened in a glove box filled with argon to retrieve the cycled cathodes and then the cathodes were examined by SEM.

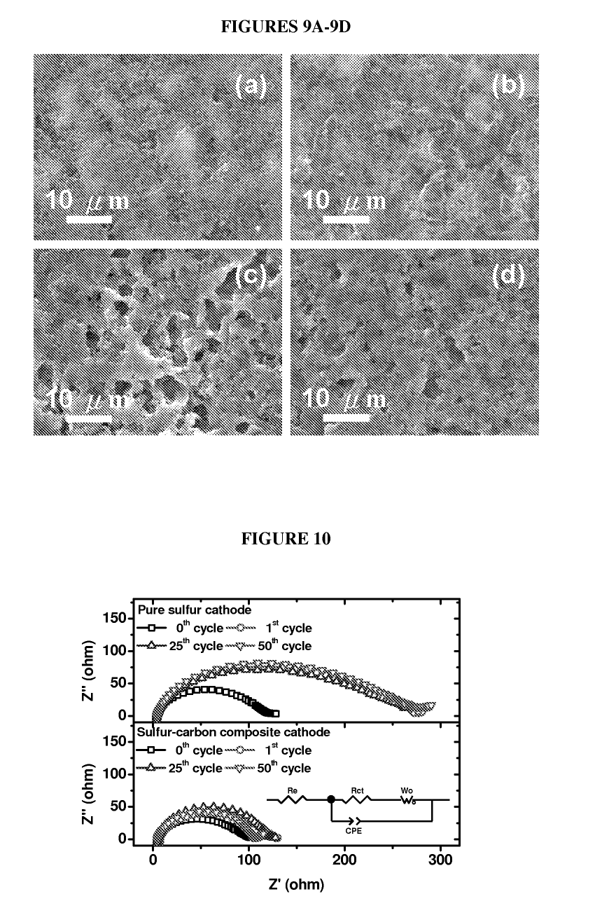

FIGS. 9A and 9B illustrate the morphology of the pure sulfur and sulfur-carbon composite cathodes, respectively, before cycling. The sulfur particles are fairly evenly distributed on the flat cathode surfaces. FIGS. 9C and 9D show the surface microstructure of the pure sulfur and sulfur-carbon composite cathodes, respectively, after the 25^{th} cycle. The sulfur-carbon composite cathode still maintains a relatively flat surface, implying the electrochemical process has limited impact on the cathode structure during cycling. This result indicates that the reduction/oxidation process of the active sulfur is effectively localized to the carbon-wrapped sulfur network structure. In contrast, a porous structure is formed in the case of pure sulfur cathode after 25 cycles. The pore size resembles the particle size of the as-synthesized pure sulfur, indicating that the active sulfur continuously leaches out during the discharge/charge process and pores are gradually formed in the cathode structure. These pores could develop into macroscopic cracks after many cycles due to the irreversible Li₂S plating on those areas, causing structural failure. In other words, sulfur particles have been distributed throughout the cathode by a conventional mixing process with the carbon black in case of pure sulfur cathode, and this structure cannot prevent the dissolution of polysulfides, resulting in poor electrochemical performance. In contrast, a conductive carbon-wrapped sulfur network structure produced by the in-situ sulfur deposition route in the case of sulfur-carbon composite not only maintains the structural integrity but also suppresses the migration of soluble polysulfides from the carbon matrix.

### Example 7

### Electrochemical Impedance Spectroscopy of a Battery Using Sulfur-Carbon Composite

The electrochemical impedance spectroscopy (EIS) of the battery of Example 4 was performed. EIS measurements were performed with a Solartron Impedance Analyzer (SI 1260+SI 1287) in the frequency range of 1 MHz to 100 mHz with an AC voltage amplitude of 5 mV. The spectra were examined both before cycling and after cycling at a rate of C/5.

To understand the reason for the excellent electrochemical performance of the sulfur-carbon composite synthesized by the in situ sulfur-deposition route, EIS measurements were carried out with the coin cells of Example 4. The Nyquist profiles of the pure sulfur and sulfur-carbon composite cathodes and the equivalent circuits are shown in FIG. 10. Rₑ refers to the resistance of electrolyte, Rₑₜ refers to the charge transfer resistance between the conductive carbon black and sulfur, Wₒ refers to the Warburg impedance, and CPE refers to the constant phase element. The resistance of electrolyte was estimated from the intersection of the front end of semicircles with the Z′ axis, which is similar for both the cathodes. The diameter of the impedance semicircles is related to the charge transfer resistance, which is a measure of the difficulty involved for charges crossing the boundary between the electrode and the electrolyte. Before cycling, the sulfur-carbon composite cathode has a lower charge transfer resistance value than the pure sulfur cathode, which is expected considering its higher first discharge capacity compared to that of pure sulfur cathode. The close contact between the conductive carbon black and the insulating sulfur lowers the resistance for electrons transferring across the interface between them. In the subsequent cycles (1^{st}, 25^{th}, and 50^{th}), the charge-transfer resistance of the pure sulfur cathode grows much larger than that found with the sulfur-carbon composite cathode. The main reason for this is the porous structure of the cycled pure sulfur cathode. Electrons passing across the boundary between conductive carbon and active material are impeded by the irreversible formation of the Li₂S layer in the pores. The EIS measurements thus reveal that the sulfur-carbon composite cathode exhibits better electronic and ionic conductivity than the pure sulfur cathode due to the close contact provided by the stable network structure of carbon black wrapping around the sulfur. The impedance of the sulfur-carbon composite after 50 cycles does not increase much, suggesting that the network structure maintains its integrity during the cycling process.

Although only exemplary embodiments of the disclosure are specifically described above, it will be appreciated that modifications and variations of these examples are possible without departing from the spirit and intended scope of the disclosure. For instance, numeric values expressed herein will be understood to include minor variations and thus embodiments “about” or “approximately” the expressed numeric value unless context, such as reporting as experimental data, makes clear that the number is intended to be a precise amount.

1. A method of synthesizing a sulfur-carbon composite comprising:
forming an aqueous solution of a sulfur-based ion and carbon source;
adding an acid to the aqueous solution such that the sulfur-based ion nucleates as sulfur upon the surface of the carbon source; and
forming an electrically conductive network from the carbon source,
wherein the sulfur-carbon composite includes the electrically conductive network with nucleated sulfur.

2. The method according to claim 1, wherein the sulfur is precipitated within the within the interspaces of the carbon source or on the surface of the electrically conductive network.

3. The method according to claim 1, wherein the acid provides hydrogen ions (H⁺) to the sulfur-based ion.

4. The method according to claim 3, wherein the acid comprises hydrochloric acid.

5. The method according to claim 1, further comprising adding a wetting agent to facilitate the distribution of the carbon source within the aqueous solution.

6. The method according to claim 4, wherein the wetting agent comprises isopropyl alcohol.

7. The method according to claim 1, wherein the carbon source is one of carbon/graphite powder, porous carbon/graphite particles, carbon nanotubes, carbon nanofibers, graphene, or combinations thereof

8. The method according to claim 1, wherein the sulfur source comprises metal thiosulfate.

9. The method according to claim 1, further comprising mixing the aqueous solution for 24 hours.

10. The method according to claim 1, wherein the sulfur-carbon composite forms a precipitate, further comprising filtering the precipitate from the aqueous solution.

11. The method according to claim 10, further comprising washing the precipitate with at least one of water, ethanol, or acetone.

12. The method according to claim 1, wherein nucleated sulfur forms granules between 0.5 and 10 micrometers in diameter.

13. The method according to claim 1, wherein nucleated sulfur is chemically bonded to the carbon source.

14. The method according to claim 1, wherein the nucleated sulfur is physically attached to the carbon source by Van der Waal's forces.

15. The method according to claim 1, wherein the electrically conductive network comprises a plurality of distinct carbon particles in electrical communication with each other.

16. The method according to claim 15, wherein the plurality of distinct carbon particles are within 10 and 100 nanometers in diameter.

17. A sulfur-carbon composite comprising:
a carbon-based material, configured such that the carbon-based material creates an electrically conductive network; and
a plurality of sulfur granules in electrical communication with the electrically conductive network, and configured such that the sulfur granules are reversibly reactive with alkali metal.

18. The sulfur-carbon composite of claim 17, wherein the carbon-based material is one of carbon/graphite powder, porous carbon/graphite particles, carbon nanotubes, carbon nanofibers, graphene, or combinations thereof

19. A battery comprising:
a cathode, comprising:
a carbon-based material, configured such that the carbon-based material creates an electrically conductive network; and
a plurality of sulfur granules in electrical communication with the electrically conductive network, and configured such that the sulfur granules are reversibly reactive with alkali metal;
an anode; and
an electrolyte.

20. The battery according to claim 19, wherein the battery retains at least 70% of its capacity after 30 cycles of charge/discharge.
